(19) United States
(12) Patent Application Publication
(10) Pub. No.: US 2001/0024247 A1
(43) Pub. Date: Sep. 27, 2001

(54) Active matrix substrate and manufacturing method thereof

(75) Inventor: Shinichi Nakata, Kagoshima (JP)

Correspondence Address: Patent Group, Hutchins, Wheeler & Dittmar, 101 Federal Street, Boston, MA, 02110, US

(73) Assignee: NEC Corporation

(21) Appl. No.: 09/805,076

(22) Filed: Mar. 13, 2001

(30) Foreign Application Priority Data
Mar. 21, 2000 (JP) 78504/2000

(51) Int. Cl. G02F 1/136

(52) U.S. Cl. 349/43; 349/141

(57) ABSTRACT

In an active matrix substrate of the IPS system, the present invention performs patterning of a protective film covering a TFT using a photosensitive resin based on an acrylic resin, and uses the acrylic resin as it is as a leveling layer after opening the protective film. Therefore, the leveling layer can be formed on the protective film without increasing the number of steps and suppressing the rubbing non-uniformity becomes possible.

### BACKGROUND OF THE INVENTION

(i) Field of the Invention

The present invention relates to active matrix substrate used for liquid crystal display devices, particularly to active matrix substrates designed for of a lateral electric field (IPS) system and manufacturing methods thereof.

(ii) Description of the Related Art

Generally, the twisted nematic (TN) type liquid crystal display device has a problem that the viewing angle is narrow since the liquid crystal molecule rises in the nearly vertical direction to a substrate.

Contrary to that, active matrix type liquid crystal display device wherein thin film transistors (hereinafter to be referred to as TFT for short) are formed on a glass substrate in a matrix form and TFT are used as switching elements have advantage of a high image quality compared with TN liquid crystal display devices since the liquid crystal molecule rotates in a plane nearly parallel to a substrate.

As a method of improving the viewing angle characteristics of the liquid crystal display device, in Japanese Patent Application Laid-open No. 5-505247, a liquid crystal display device of an IPS (an abbreviation of In-Plane-Switching; hereinafter to be referred to as IPS) system is proposed. In the IPS liquid crystal display device, two electrodes are both formed on one substrate and a voltage is applied between these two electrodes to generate an electric field horizontal with the substrate, and then the liquid crystal molecule is driven to rotate with being kept horizontal with the substrate. In this method, when the voltage is applied, the long axis of the liquid crystal molecule never rises in the plane orthogonal with the substrate. From this reason, the change in brieffringence of liquid crystal is small when the viewing angle is changed resulting in viewing angle of the display device becomes wide.

The active matrix type liquid crystal display device of an IPS system wherein two electrodes are both formed on one substrate will be described below. This TFT liquid crystal display device of an IPS system is constructed as shown in FIG. 1 and FIG. 2. FIG. 1 shows a sectional view along line D-D′ in FIG. 2.

First, a gate electrode 62 and a common electrode 63 made of Cr are formed on a glass substrate 61, and a gate insulation layer 64 made of silicon nitride is formed on these electrodes to cover them. On the gate electrode 62, a semiconductor region 65 is formed on the gate insulation layer 64 to function as an active layer of a transistor.

A drain electrode 66 and a source electrode 67 made of Cr are formed to overlap part of the semiconductor region 65, and a protective film 68 made of silicon nitride is formed to cover all of these.

As shown in FIG. 2, between a pixel electrode 77 as an extension line of the source 67 and the common electrode 63 as an extension line of a common wiring 263, the area of one pixel is disposed. On a surface of an active matrix substrate wherein unit pixels constructed as above are disposed in a matrix form, an alignment layer 70 is formed, and a surface of this alignment layer 70 is rubbing-processed.

On an inner surface of an opposite glass substrate 161 opposing to the glass substrate 61, an alignment layers 170 is provided such that the alignment layers 70 and 170 are faced to each other, and then a liquid crystal composition 71 is filled therebetween.

On the outside surfaces of the glass substrate 61 and 161, a polarizers 74 and 174 are formed, respectively.

A light shield layer 73 partitioning a color filter layer 72 is formed so that its partial region is disposed above a thin film transistor consisted of the semiconductor region 65. The opposite substrate 161 has an construction wherein the color filter layer 72 is formed on the substrate 161 separated by a light shielding layer 73 and further an alignment layer 170 are formed on the color filter layer 72 and the light shielding layer 73 to cover them.

In the active matrix type liquid crystal display device constructed as above, when no electric field is applied to the liquid crystal composition, as shown in the plan view of FIG. 2, the liquid crystal molecule is aligned as the liquid crystal molecule 171 being indicated in a generally parallel state with a parallel direction of those electrodes and homogeneous-oriented.

More specifically, the liquid crystal molecule is oriented such that the angle between a direction of the long axis (optical axis) of the liquid crystal molecule and an electric field direction formed between the pixel electrode 77 and the common electrode 63 is 45° or more but less than 90°. The orientation direction of the liquid crystal molecule are aligned in parallel with the surface of the glass substrate 61 as shown in FIG. 1. It is assumed that the dielectric anisotropy of the liquid crystal molecule is positive.

Here, when the thin film transistor (TFT) is turned on by applying an voltage to the gate electrode 62, the voltage is applied to the source electrode 67 and the pixel electrode 77 and an electric field is induced between the pixel electrode 77 and the common electrode 63. By this electric field, the orientation direction of the liquid crystal molecule 171 changes its direction getting close to a direction of the electric field resulting in coinciding the disposition of the liquid crystal molecule 271. This liquid crystal molecule is aligned in a substantially parallel with the direction of the electric field formed between the pixel electrode 77 and the common electrode 63. By disposing the polarizer orientation of the polarizer 74 and 174 at a predetermined angle, the transmissivity of lights can be changed by the above-described movement of the liquid crystal molecule.

In the above-described active matrix type liquid crystal display device of the IPS system, the long axis of the liquid crystal molecule is substantially in parallel with the substrate surface and never rises in the plane orthogonal with the substrate by applying a voltage between the the pixel electrode 77 and the common electrode 63. From this reason, when the viewing angle direction is changed, the change in brightness is small, and it has an effect that the viewing angle characteristics are considerably improved.

However, the liquid crystal display device of the IPS system as mentioned above has features in the side of the active matrix substrate and then problems caused by the features as indicated below.

That is, in the IPS system, because of an element structure wherein the applied electric field direction and the light transmissive direction differ, unlike the conventionally widely used TN system, the pixel electrode and the common electrode forming the electric field for driving the liquid crystal must not always be transparent. In practice, it is desirable to use a metal electrode because the resistance is low and it can be easily formed. Both electrodes of the pixel electrode and the common electrode in the liquid crystal display device of the IPS system are like the teeth of a comb and formed to mutually interpose the teeth of the comb. Furthermore, for obtaining a more uniform lateral electric field wherein the threshold voltage is low, there is a necessity that the electrode wiring width and the distance between the wirings are minutely formed.

However, as a result of minutely forming the electrode wiring width and the distance between the wirings, it has been found that alignment inferiority occurs by using the TFT structure. For details , to align the liquid crystal, that is, to give an aligning force to the liquid crystal molecule constituting the liquid crystal layer, in general, rubbing processing to the alignment layer is performed. But, at that time by the relationship in height between the electrodes, a defective area in which rubbing is insufficient or which is not rubbed is generated. The defective area locates in particular near along the electrodes, and when observing the display in a “black” display mode, a so-called white pin hole is generated.

It is thinkable that the difference of the aligning force caused by rubbing processing depends on the size of the concave portion between the electrodes and the thickness of the fiber used in the rubbing cloth. After all, because an area wherein the step between the electrodes by the electrodes is small is easy to be rubbed and an area wherein the step between the electrodes is large is hard to be rubbed, the areas different in aligning force are generated. By this difference in aligning force, the alignment uniformity of the liquid crystal is disturbed. In a state that the step on the surface of the alignment layer is small or there is no step, rubbing to the alignment layer is easy to be uniformly performed and no defective alignment area is generated, but the step of the protective film generated by the pixel electrode and the common electrode generates the step of the surface of the alignment layer, and as shown in the sectional view of FIG. 1, in case that the step by the electrodes is large, because it is hard to be rubbed, an defective area is generated in the alignment layer.

### SUMMARY OF THE INVENTION

Accordingly, it is an object of the present invention to provide an active matrix substrate of an IPS system and a manufacturing method thereof, wherein the alignment deterioration by the step caused by the difference in height between these electrodes or the height itself of the electrode is suppressed and good rubbing processing can be performed.

The present invention is featured in that a leveling layer coated on a protective layer formed on an active matrix substrate for IPS system is made of photosensitive.

In an active matrix substrate according to the first aspect of the present invention, a plurality of switching elements are arranged on a substrate such that each of the switching elements are associated with a corresponding pixel area.

Gate electrodes are formed on the substrate so as to be associated with the switching elements, and data electrodes are also arranged on the substrate so as to be connected to the switching elements.

A plurality of pixel electrodes are arranged on the substrate so as to be connected to the switching elements, respectively.

Common electrodes are formed on the substrate adjacent to the pixel electrode for determining the pixel area, and a protective layer is formed on the switching elements and the pixel electrodes so as to cover the gate electrode and the common electrode.

Then a leveling layer made of a photosensitive resin is formed on the protective layer In the above stated invention, the gate electrodes and the common electrodes may be commonly coated with a gate insulating layer, and the pixel electrodes are formed on the gate insulating layer.

The active matrix substrate according to the second aspect of the present invention, the gate electrodes and the common electrodes are coated with a laminated layers of a gate insulating layer and a semiconductor layer such that the laminated layers on the gate electrodes are isolated from those formed on the common electrodes, and the pixel electrodes are formed on the substrate exposed from the laminated layers.

In accordance with the aspect of the invention, the protective layer is provided with terminal opening areas at a terminal region of the gate electrodes.

Preferably the photosensitive resin is an acrylic resin, and an alignment layer is formed on the leveling layer.

According to the present invention, a liquid crystal display device is obtained by arranging an opposite substrate and the above stated active matrix substrate so as to sandwich a liquid crystal layer therebetween.

Next, in a manufacturing method of an active matrix substrate according to the first aspect of the present invention,

A gate wiring to serve also as a gate electrode and a common wiring are formed on a substrate.

A first insulation layer is formed to cover the gate wiring and the common wiring, and a semiconductor layer is formed on the first insulation layer.

A source wiring is connected to the semiconductor layer to serve also as a source electrode and a drain wiring connected to the semiconductor layer to serve also as a drain electrode on the semiconductor layer.

A second insulation layer is formed to cover the semiconductor layer, the source wiring and the drain wiring and a third insulation layer is formed on the second insulation layer.

A common electrode and a pixel electrode are formed so as to be disposed in parallel with each other.

An upper layer portion of the second insulation layer is formed by a photosensitive resin having a transparency of 90% and over when measuring the transparency at the light wave length of 400 nm.

The manufacturing method of the active matrix substrate according to the second aspect of the present invention, after forming the gate wiring and the common wiring, the first insulation layer and the semiconductor layer are deposited in order on the gate wiring and the common wiring and then patterned in the same pattern to generate layered structure pattern consisted of the first insulation layer and the semiconductor layer.

The manufacturing method of the active matrix substrate according to the third aspect of the present invention, the surface other than the bottom surface of each of the gate wiring and the common wiring is covered by the first insulation layer in the area other than a terminal area and a termination area.

The manufacturing method of the active matrix substrate according to the fourth aspect of the present invention, the photosensitive resin is formed by coating, exposing, developing, and heating the photosensitive resin and the second insulation layer has a protective film below the photosensitive resin.

The manufacturing method of an active matrix substrate has fifth application, wherein terminal opening areas are formed in the second insulation layer by opening the terminal opening areas of the photosensitive resin in a terminal of the gate wiring and a terminal of the drain wiring, and further opening the terminal opening areas of the protective film through the terminal opening areas of the photosensitive resin.

In accordance with the above aspects of the invention, the photosensitive resin is formed based on an acrylic resin and the third insulation layer is an alignment layer.

### BRIEF DESCRIPTION OF THE DRAWINGS

FIG. 1 is a sectional view of a conventional liquid crystal display device of an IPS system (D-D′ line in FIG. 2);

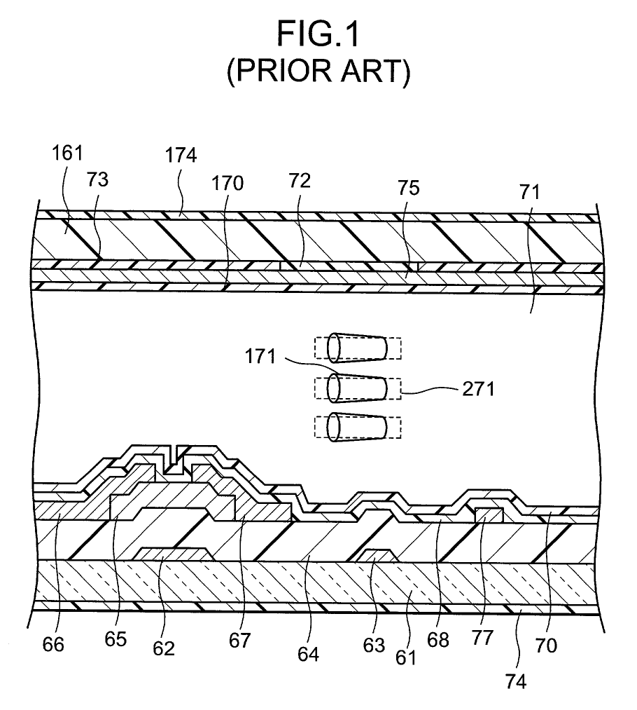

FIG. 2 is a plan view of an active matrix substrate of the prior art;

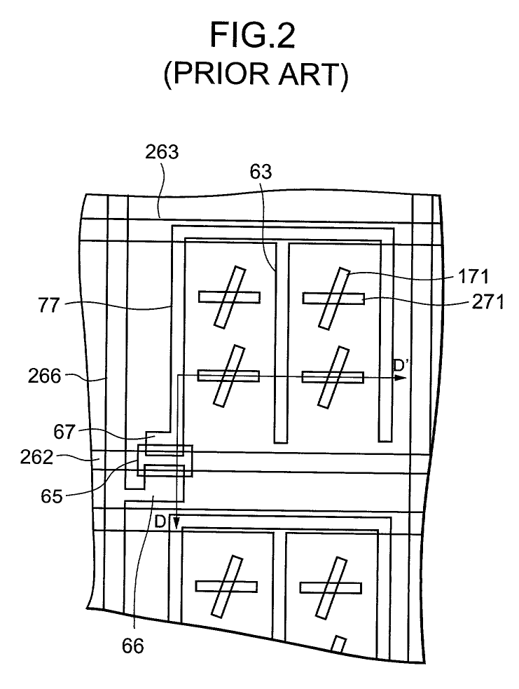

FIG. 3 is a circuit conceptual view of an active matrix substrate for a liquid crystal display device of a general lateral electric field system;

FIG. 4 is a plan view in the vicinity of a pixel electrode of an active matrix substrate according to the first embodiment of the present invention;

FIG. 5 is a sectional view along a cutoff line A-A′ in FIG. 4;

FIGS. 6A to 6D are sectional views showing a manufacturing method of the active matrix substrate according to the first embodiment of the present invention in the order of manufacturing steps;

FIGS. 7A and 7B are sectional views for illustrating electrode forming steps of a gate terminal area of the active matrix substrate according to the first embodiment of the present invention;

FIGS. 8A and 8B are sectional views for illustrating electrode forming steps of a drain terminal area of the active matrix substrate according to the first embodiment of the present invention;

FIG. 9 is a plan view in the vicinity of a pixel electrode of an active matrix substrate according to the second embodiment of the present invention;

FIGS. 10A and 10B are sectional views along a cutoff line B-B′ and a cutoff line C-C′ in FIG. 9, respectively;

FIGS. 11A and 11B are sectional views showing a manufacturing method of the active matrix substrate according to the first embodiment of the present invention in the order of manufacturing steps; and

FIGS. 12A and 12B are sectional views showing manufacturing steps subsequent to FIG. 11B.

### DETAILED DESCRIPTION OF THE PREFERRED EMBODIMENTS

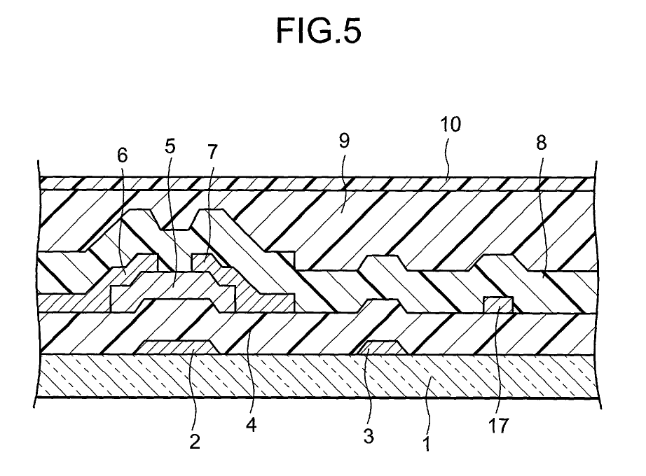

Referring to FIG. 5, a gate electrode 2 and a common electrode 3 are formed on a glass substrate 1, and a gate insulation layer 4 is formed to cover them. A semiconductor region 5 is formed thereon to overlap the gate electrode 2. A source electrode 7 and a data electrode or a drain electrode 6 are connected to the semiconductor region 5 through ohmic contact layers (not shown), respectively. An ohmic contact layer extending between the source electrode 7 and the drain electrode 6 is etched off, and a construction is made wherein the ohmic contact layers (not shown) are formed only between the source electrode 7 and the semiconductor region 5 and the drain electrode 6 and the semiconductor region 5, respectively. Further, including a back channel portion, which is formed by etching the ohmic contact layer slightly excessively into the semiconductor region 5, as part of the semiconductor region 5, a protective film 8 is formed to cover these, a leveling layer 9 is formed to cover them, and further an alignment layer 10 is formed at the uppermost layer. In the following description, the illustration of the alignment layer is omitted for simplification.

As for a manufacturing method of the leveling layer 9, because the protective film 8 is formed to cover the back channel portion of the TFT, the source electrode 7, a drain wiring (not shown), the drain electrode 6, and the protective film 8 of a drain terminal (not shown) is necessary to be opened for connection with the external electric signal source. Conventionally, a photosensitive resist based on a novolak resin is coated on the protective film 8 and the opening of the terminal area is formed by using a photolithography process, and then the protective film 8 disposed on the drain terminal is opened. But after that the photosensitive resist based on the novolak resin has to be removed since the novolak resin is easy to flow under high temperature environment and shows low transparency which means the novolak resin can not be used as a leveling layer of the display device. Instead, in the present invention, a photosensitive resin based on an acrylic resin is used for coating.

The photosensitive resin based on this acrylic resin is exposed and developed by a photolithography and the acrylic resin at the area necessary to open the protective film is removed.

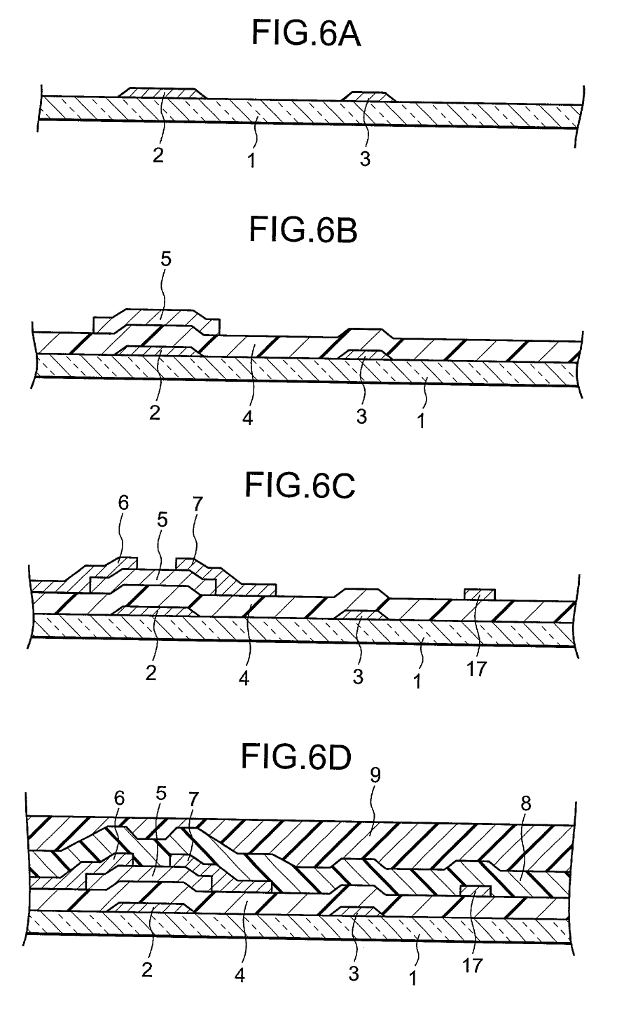

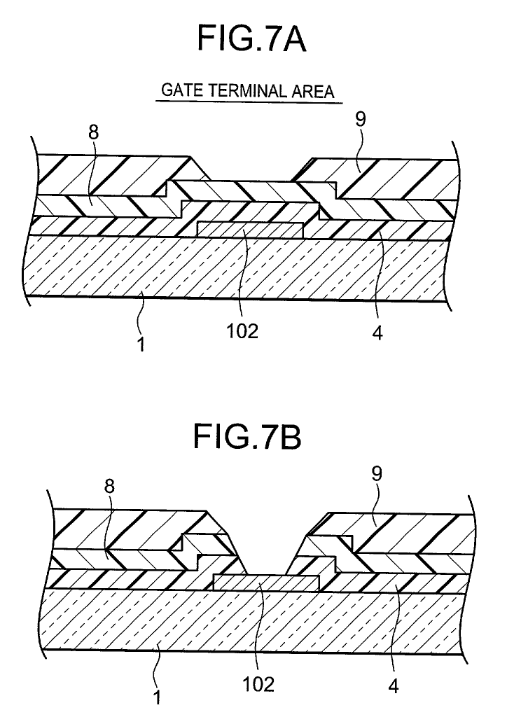

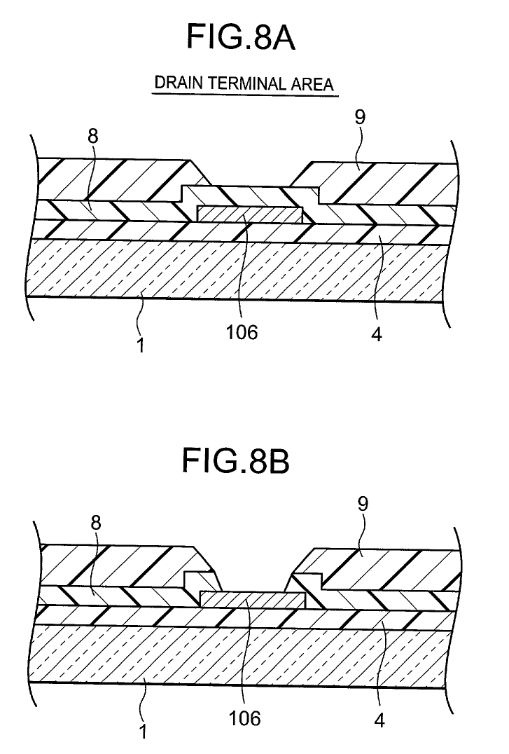

Next, as shown in FIGS. 7A and 7B, and FIG. 8A and 8B, after the protective film 8 is opened using the leveling layer 9 based on this acrylic resin as a mask, baking of the acrylic resin at 230° C. for one hour is performed, and it is used as it is as the leveling layer 9 for leveling the surface unevenness reflecting the step or the like of the TFT and the drain electrode (FIG. 6D). In case that a positive photoresist is used as a photosensitive agent of the acrylic resin, for ensuring the transparency of the acrylic resin, a whole surface of the acryic resin is exposed before baking and decoloring processing is performed to the acryic resin.

A manufacturing method of the active matrix substrate of the present invention is characterized in that the active matrix substrate in which unevenness by the TFT and the electrode group is leveled is manufactured by the manufacturing method as described above without increasing the number of steps.

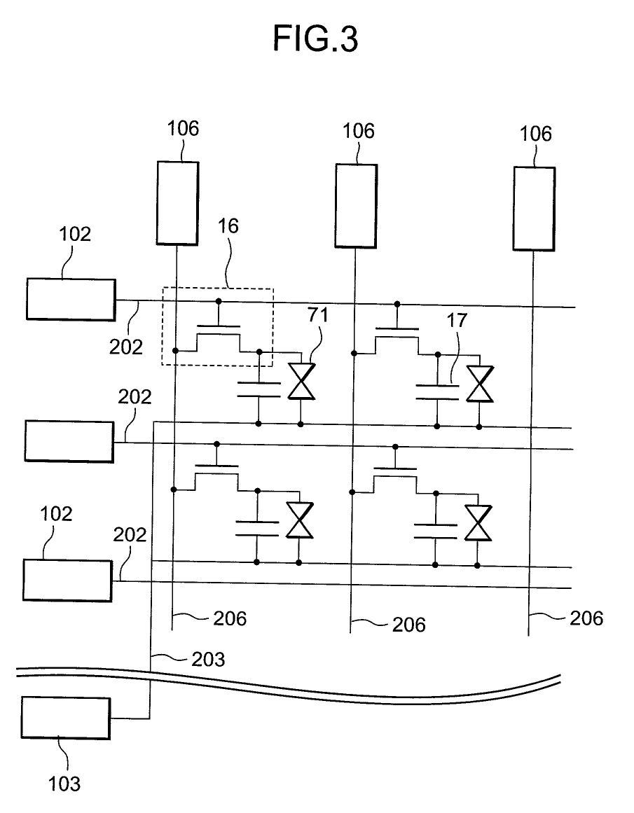

Next, the first embodiment of the present invention will be described in detail with reference to FIGS. 3 to 8B. A liquid crystal display device of the present invention will be described with showing an example wherein a TFT is used as a switching element. FIG. 3 is a circuit diagram showing the construction of an active matrix substrate in the liquid crystal display device.

On a glass substrate, gate wirings 202 (the gate wirings are led out to gate terminals 102) and drain wirings 206 (the drain wirings are led out to drain terminals 106) are disposed to cross perpendicularly with each other, and TFTs 16 and pixel electrodes 17 are formed to correspond to the crossing portions of these signal lines. The gate wiring 202 is connected to a gate electrode of the TFT 16 and the TFT 16 corresponding to a pixel is driven by a scanning signal input to the gate electrode through the gate wiring 202.

The drain wiring 206 is connected to a drain electrode of the TFT 16 and inputs a data signal to the drain electrode. To a source electrode 7 of the TFT 16, a pixel electrode 17 in the shape of the teeth of a comb is connected to constitute a source wiring. Each pixel electrode partially overlaps an adjacent common wiring 203 (the common wiring is led out to a common terminal 103) on the gate insulation layer and serves as an additional capacitance electrode.

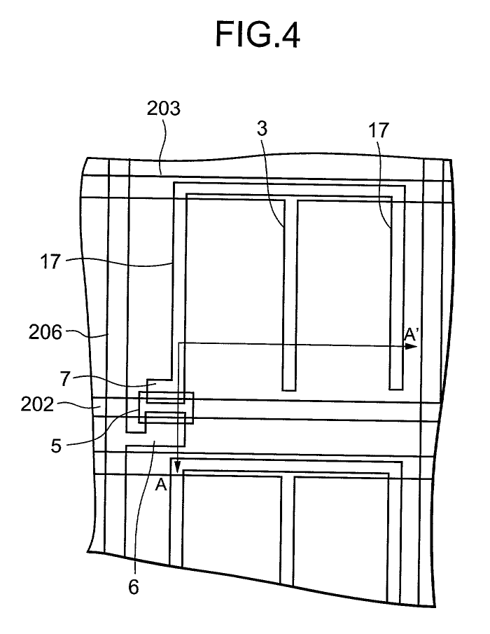

As shown in FIG. 4 and FIG. 5, a gate electrode 2 is formed on a glass substrate 1, and a gate insulation layer 4 is formed to cover it. A semiconductor region 5 is formed thereon to overlap the gate electrode 2, and a source electrode 7 and a drain electrode 6 are connected respectively to the semiconductor region 5 through ohmic contact layers (not shown). An ohmic contact layer between those source electrode 7 and drain electrode 6 is etched off, and the ohmic contact layer (not shown) are formed only between the source electrode 7 and the semiconductor patter 5 and the drain electrode 6 and the semiconductor region 5.

Furthermore, including a back channel portion wherein the ohmic contact layer is etched off, a protective film 8 is formed to cover these, and a leveling layer 9 is formed to cover them.

The present invention can be applied to any liquid crystal display device wherein the leveling layer 9 made of an organic film is formed on the protective film 8 covering the TFT, and a color filter layer or a black matrix layer may exist below the leveling layer 9 as one of other applications of this invention.

Besides, as the switching element, there is no particular limit and it is not limited to the TFT but may be such as an MIM, a diode, besides, as the TFT, it is not an inverted staggered type wherein the gate electrode positions below the semiconductor region but may be a normal staggered type.

Besides, in the liquid crystal display device of the present invention, as for the construction other than the above, there is no particular limit, for example, the liquid crystal material, the alignment layer, the opposite substrate, the electrode for the opposite substrate, and so on may be constructed as those that are generally used in an active matrix type liquid crystal display device.

A manufacturing method of the first embodiment of the present invention will be described with reference to FIGS. 6A to 8B as manufacturing process views for obtaining the sectional construction of FIG. 5. FIGS. 6A to 6D show a manufacturing method of a pixel display area and FIGS. 7A and 7B show the construction of its terminal.

As shown in FIG. 6A, for example, a gate electrode 2 and a common electrode 3 are formed on a glass substrate 1. This process can be performed as follows in accordance with the prior art. A conductive layer made of Al, Mo, Cr, or the like is deposited on the glass substrate 1 by sputtering in a thickness of 100 to 400 nm, and a gate wiring (not shown), the gate electrode 2, the common electrode 3, and a gate terminal 102 (FIGS. 7A and 7B) connected to an external signal processing substrate for display are formed by a photolithography.

Next, as shown in FIG. 6B, a gate insulation layer 4 made of silicon nitride or the like, a semiconductor layer 5 made of amorphous silicon, and an ohmic contact layer (which is included in the semiconductor layer and whose illustration is omitted) made of n⁺-type amorphous silicon are continuously deposited on the glass substrate 1 by plasma CVD in a thickness of about 400 nm, 300 nm, and 50 nm, respectively, and the semiconductor layer and the ohmic contact layer are patterned to same pattern generating semiconductor region 5.

Next, as shown in FIG. 6C, a metal of Mo, Cr, or the like is deposited on the gate insulation layer 4 covering the semiconductor layer 5 by sputtering in a thickness of 100 to 200 nm to cover the gate insulation layer 4 and the ohmic contact layer of the semiconductor region 5, and the metal is patterned by a photolithography into a source electrode 7 and a pixel electrode 17, a drain wiring (not shown), a drain electrode 6, and a drain terminal 106 (FIGS. 8A and 8B) connected to the external signal processing substrate for display, as an extension of it, and, in order to form a back channel portion of the TFT, the unnecessary ohmic contact layer other than the portion just below the source electrode 7 and the drain electrode 6 is removed.

Next, as shown in FIG. 6D, a protective film 8 made of an inorganic film such as a silicon nitride film is formed on the gate insulation layer 4 covering a back channel region of TFT, the source electrode 7, the drain wiring (not shown), the drain electrode 6 and the drain terminal 106 (refer to FIG. 8) in a film of a thickness of about 100 to 200 nm by plasma CVD to cover the back channel portion of the TFT, the source electrode 7, the drain wiring (not shown), the drain electrode 6, and the drain terminal 106 (FIGS. 8A and 8B).

Because this protective film 8 is necessary to be opened in the terminal area, a photosensitive resin 9 based on acrylic resin is coated on the protective film 8 and then opened above the drain terminal.

The photosensitive resin 9 based on acrylic resin is formed and the protective film 8 of the drain terminal is opened as follows:

First, the photosensitive resin 9 based on the acrylic resin is coated with spinning speed of 1200 rpm on the protective film 8 and heated as a pre-baking at the temperature of 90° C. for three minutes; the photosensitive resin 9 is exposed by an exposure intensity of 1.5 J/cm² in case of using g-line exposure light;

the photosensitive resin 9 is developed with a liquid developer of 0.2% TMAH (Tri-Methyl-Ammonium-Hydride) solution for 100 sec;

the photosensitive resin 9 is post-exposed by an exposure intensity of 600 mJ/cm2 in case of using g-line exposure light;

the photosensitive resin 9 is heated as a post-baking at the temperature of 230° C. for one hour (FIG. 7A and FIG. 8A);

the protective film 8 is opened through the opening of photosensitive resin 9 by dry-etching under the condition of etching gas including He flow rate of 250 sccm and SF6 flow rate of 45 sccm, vacuum pressure being 30 Pa, RF power being 1200 W, the distance between the under surface of the plate and the substrate (hereinafter, it is called the gap) being 150 mm, etching time being 280 seconds (FIG. 7B and FIG. 8B).

Thus formed photosensitive resin 9 is used as it is as the leveling layer 9 for leveling unevenness of the surface of the protective film 8 generated by the step or the like of the TFT and the drain electrode (FIG. 6D). At this time, as shown in FIG. 7B, since the upper portion of the gate terminal 102 is covered by the gate insulation layer 4 and the protective film 8 in the order from below, after the protective film 8 is opened, the gate insulation layer 4 is also opened along the opening portion. In case that a positive photoresist is used as a photosensitive agent of the acrylic resin, for ensuring the transparency of the acrylic resin, a whole surface of the acrylic resin is exposed by post-exposure before post-baking and then decoloring processing of the acrylic resin is performed.

After this, the substrate manufactured as described above is disposed to oppose an opposite substrate to the substrate following an ordinary manufacturing method and a liquid crystal is injected between the two substrates to complete the liquid crystal display device.

As described above, according to this embodiment, in the liquid crystal display device of the IPS system, by forming the leveling layer on the protective film, the defective alignment layer caused by rubbing non-uniformity by the unevenness of the TFT and the drain electrode can be suppressed.

Besides, in this embodiment, by forming the leveling layer formed on the protective film by using the photosensitive resin based on the acrylic resin, the leveling layer can be formed without increasing the number of steps.

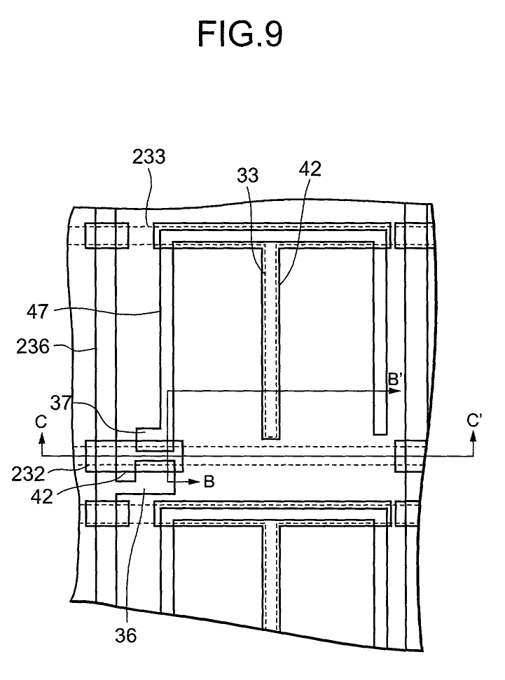

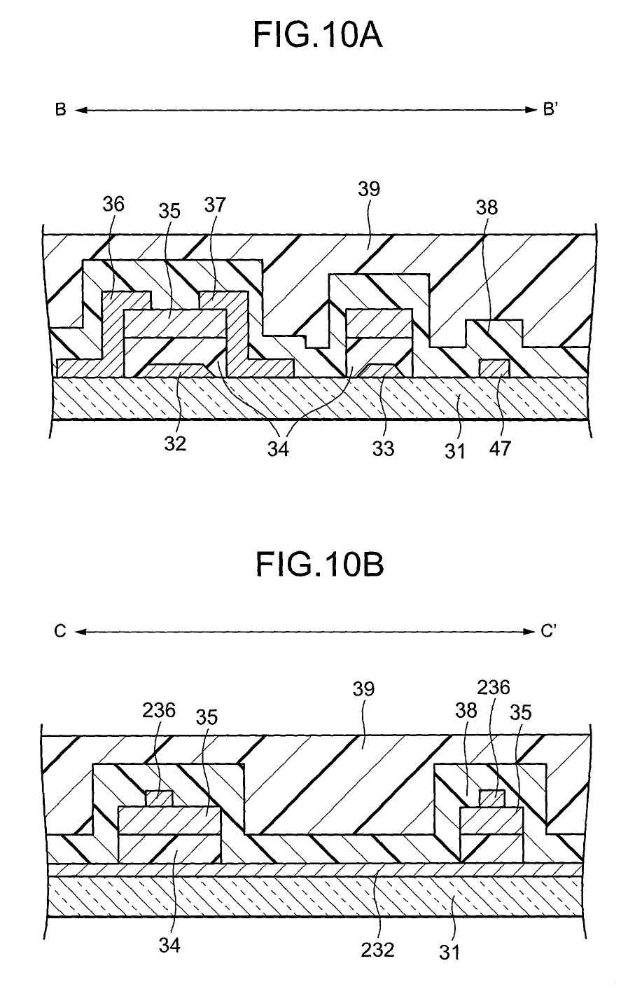

Next, the second embodiment of the present invention will be described with reference to FIGS. 9 to 12B.

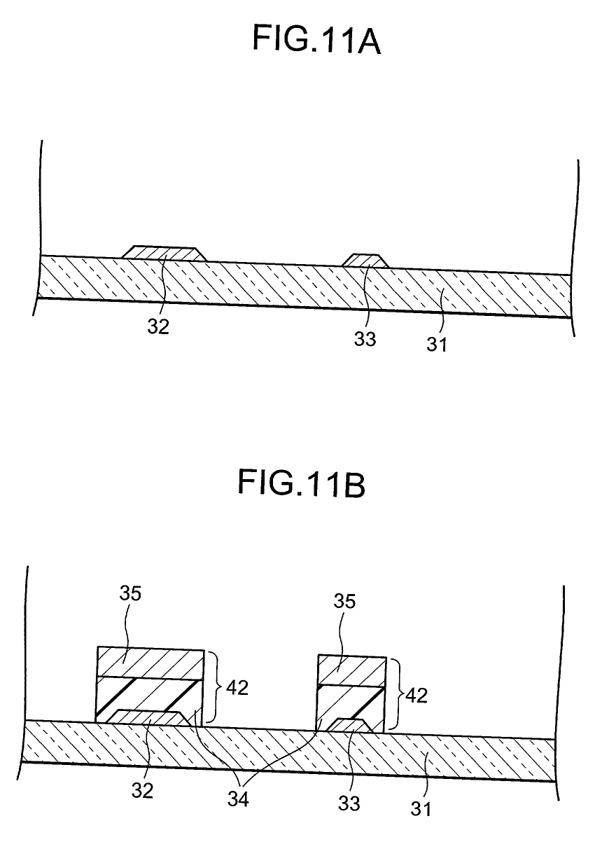

First, a gate electrode 32, a gate wiring 232, and a common electrode 33 are formed on a glass substrate 31 (FIG. 11A), and a gate insulation layer and a semiconductor layer are formed to cover them. Then, first, the gate insulation layer and the semiconductor layer other than the area covering the gate electrode 32, the gate wiring 232, the common electrode 33, and a common wiring 233 are removed, and subsequently, in order that a layered structure pattern 42 consisted of insulation layer and semiconductor layer in lower order is formed only in the vicinity of the crossing portion of the gate wiring 232, the common wiring 233, and a drain wiring 236, in the vicinity of the gate electrode 32, and in the vicinity of the common electrode 33, the semiconductor layer in the other area is removed to form the semiconductor region 35 and the gate insulation pattern 34(FIG. 11B).

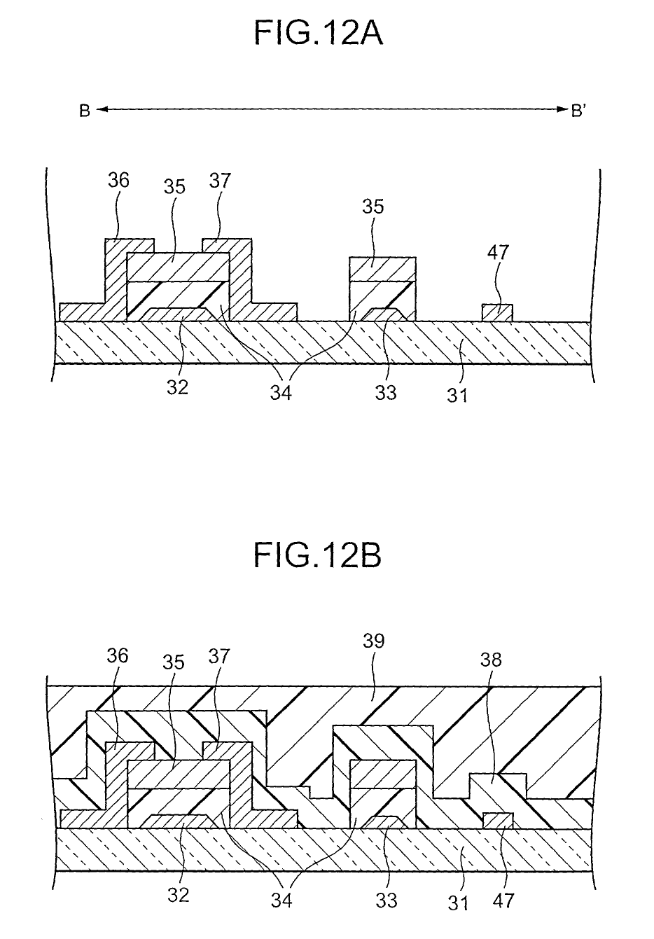

A source electrode 37 and a drain electrode 36 separated on the central portion of the semiconductor region 35 are connected to the semiconductor region 35 through an ohmic contact layer. The ohmic contact layer between those source electrode 37 and drain electrode 36 is etched off, and the ohmic contact layer (not shown) is formed only between the source electrode 37 and the semiconductor region 35 and the drain electrode 36 and the semiconductor region 35 (FIG. 12A).

Furthermore, including a back channel portion wherein the ohmic contact layer is etched off, a protective film 38 is formed to cover these, and further a leveling layer 39 is formed to cover the upper portion of it (FIG. 12B). In this embodiment the protective film 38 and the leveling layer 39 are formed in the same manufacturing process as in the first embodiment.

In this embodiment, since the pixel electrode 47 and the common electrode 33 are positioned in the same plane, an electric field when a voltage is applied between those electrodes is efficiently transmitted to a liquid crystal molecule and the aligning performance of the liquid crystal molecule can be improved.

Besides, in this embodiment, although the layered structure of three layers of the gate electrode, gate insulation pattern, and semiconductor region on the glass substrate generates unevenness on the surface of the glass substrate as it is as a step and a larger step than that of the first embodiment is formed. Even under such bad flatness condition of the surface of the glass substrate, if the leveling layer of the present invention is used, the surface of the glass substrate can be leveled without increasing the number of steps.

As described above, according to the active matrix substrate of the present invention and the manufacturing method thereof, in the liquid crystal display device of the IPS system, by forming the leveling layer formed on the protective film by using the photosensitive resin based on the acrylic resin, the leveling layer can be formed without increasing the number of steps, and the rubbing non-uniformity caused by the unevenness of the TFT and the drain electrode can be suppressed.

What is claimed is:

1. An active matrix substrate comprising:
a plurality of switching elements arranged on a substrate, each of said switching elements being associated with a corresponding pixel area;
gate electrodes formed on said substrate so as to be associated with said switching elements; data electrodes arranged on said substrate so as to be connected to said switching elements;
a plurality of pixel electrodes arranged on said substrate and being connected to said switching elements, respectively;
common electrodes formed on said substrate adjacent to said pixel electrode for determining said pixel area;
a protective layer formed on said switching elements and said pixel electrodes so as to cover said gate electrode and said common electrode; and
a leveling layer formed on said protective layer, said leveling layer being made of a photosensitive resin.

2. The active matrix substrate according to claim 1, wherein said gate electrodes and said common electrodes are commonly coated with a gate insulating layer, and said pixel electrodes are formed on said gate insulating layer.

3. The active matrix substrate according to claim 1, wherein said gate electrodes and said common electrodes are coated with a laminated layers of a gate insulating layer and a semiconductor layer such that said laminated layers on said gate electrodes are isolated from those formed on said common electrodes, and said pixel electrodes are formed on said substrate exposed from said laminated layers.

4. The active matrix substrate according to claim 1, wherein said protective layer is provided with terminal opening areas at a terminal region of said gate electrodes.

5. The active matrix substrate according to claim 1, wherein said photosensitive resin is an acrylic resin.

6. The active matrix substrate according to claim 1, further comprising an alignment layer formed on said leveling layer.

7. A liquid crystal display device comprised of an opposite substrate opposing said active matrix substrate of claim 1 so as to sandwich a liquid crystal layer therebetween.

8. A manufacturing method of an active matrix substrate comprising: forming a gate wiring to serve also as a gate electrode and a common wiring on a substrate, forming a first insulation layer to cover said gate wiring and said common wiring, forming a semiconductor layer on said first insulation layer, forming a source wiring connected to said semiconductor layer to serve also as a source electrode and a drain wiring connected to said semiconductor layer to serve also as a drain electrode on said semiconductor layer, and forming a second insulation layer to cover said semiconductor layer, said source wiring, and said drain wiring and a third insulation layer on it, wherein, a common electrode and a pixel electrode in parallel with each other are formed in said common electrode and said source electrode respectively, and the upper layer portion of said second insulation layer is formed by a photosensitive resin having a transparency of 90% and over when measuring the transparency at the light wave length of 400 nm.

9. The manufacturing method of an active matrix substrate according to claim 8, wherein after forming said gate wiring and said common wiring, said first insulation layer and said semiconductor layer are deposited in order on said gate wiring and said common wiring and then patterned in the same pattern to generate layered structure pattern consisted of said first insulation layer and said semiconductor layer.

10. The manufacturing method of an active matrix substrate according to claim 8, wherein the surface other than the bottom surface of each of said gate wiring and said common wiring is covered by said first insulation layer in the area other than a terminal area and a termination area.

11. The manufacturing method of an active matrix substrate according to claim 8, wherein said photosensitive resin is formed by coating, exposing, developing, and heating said photosensitive resin.

12. The manufacturing method of an active matrix substrate according to claim 8, wherein said second insulation layer has a protective film below said photosensitive resin.

13. The manufacturing method of an active matrix substrate according to claim 8, wherein terminal opening areas are formed in said second insulation layer by opening said terminal opening areas of said photosensitive resin in a terminal of said gate wiring and a terminal of said drain wiring, and further opening said terminal opening areas of said protective film through said terminal opening areas of said photosensitive resin.

14. The manufacturing method of an active matrix substrate according to claim 8, wherein said photosensitive resin is formed based on an acrylic resin.

15. The manufacturing method of an active matrix substrate according to claim 8, wherein said third insulation layer is an alignment layer.
